(19) United States
(12) Patent Application Publication
(10) Pub. No.: US 2015/0367267 A1
(43) Pub. Date: Dec. 24, 2015

(54) FILTERING METHODS FOR FLUIDS AND DEVICES FOR CARRYING OUT SAID METHODS

(71) Applicants: WORLD MINERALS FRANCE S.A.S., Paris (FR); FIBRA SOLUTIONS LIMITED, Reading, Berkshire (GB)

(72) Inventors: AMÉLIE MARION LEFÈVRE, LA GARDE (FR); ANDREW MARK RILEY, CORNWALL (GB); MICHAEL JOHN HUGHES, GREYWELL, HAMPSHIRE (GB)

(21) Appl. No.: 14/766,368

(22) PCT Filed: Mar. 10, 2014
(86) PCT No.: PCT/EP2014/054576

§ 371 Date: Aug. 6, 2015

(30) Foreign Application Priority Data
Mar. 8, 2013 (EP) 13290047.3

(51) Int. Cl. B01D 37/02; A23L 2/38; C02F 1/00; A23L 1/015; B01D 39/14; B01D 29/66

(52) U.S. Cl. CPC B01D 37/02; B01D 39/14; B01D 29/66; C02F 1/004; A23L 1/015; A23L 2/38; A23V 2002/00

(57) ABSTRACT

Methods for filtering fluid suspensions to obtain clarified fluids may include providing a fluid to be filtered, wherein the fluid contains solid particulate contaminants. The method may further include providing a constricted-fibre filtering device, providing a particulate filter aid, and filtering the fluid to be filtered and the particulate filter aid using the constricted-fibre filtering device. The method may further include collecting a filtered fluid and optionally filtering the collected filtered fluid again, using the constricted-fibre filtering device. A constricted-fibre filtering device may include an inlet for a fluid to be filtered and/or particulate filter aid, wherein the inlet includes a manifold leading to feeds arranged near or within fibres of the filtering device.

### FIELD OF THE INVENTION

The present invention relates to a method for filtering fluid suspensions to obtain clarified fluids and to devices for carrying out such methods.

### BACKGROUND OF THE INVENTION

Filtering of fluids to obtain clarified fluids is commonly used in a variety of industries, such as the food industry, the process industry and the water treatment industry. The principles of having a fluid filtration wherein a plurality of fibres extend longitudinally in the direction of a flow of a fluid to be filtered, and wherein the quality of the filtration is controlled by adjusting the compression and thereby the density of the fibres, are known.

WO 02/24306 A1 discloses a device for filtering a fluid comprising a fibre housing having an inlet end and an outlet end and surrounding and defining an outer bound for a plurality of fibres extending longitudinally in the fibre housing between the inlet and the outlet, whereby longitudinally extending interspaces are provided between the fibres, with said interspaces defining a plurality of flow passages (or temporary pores) for the fluid. At least part of the fibre housing is formed of a flexible membrane surrounding the fibres, and compressing means is provided for creating a pressure on an outer surface of the flexible membrane thereby compressing the fibres in a radial direction in at least one location along the length of the fibres. During the filtering operation, the fibres are compressed in a radial direction by the flexible membrane, in order to provide temporary pores between the fibres for the fluid to be filtered to flow through, optionally by exertion of a pumping pressure onto the fluid to be filtered. Any particulate contaminants in the fluid are filtered out due to the narrow size of said temporary pores. After termination of the filtering operation, the filter can be regenerated by releasing the pressure from the flexible membrane and thereby expanding the space available to the fibres and opening up the temporary pores which can then be flushed with a flushing fluid to remove the accumulated particulate contaminants. Filtrate and flushing liquid can be collected through a filter outlet.

The disadvantage of this technique is that the minimal particle size of the particles to be separated from the fluid is limited by the temporary pore size created by the compressed fibres.

An alternative filtration device using the same principle is disclosed in EP 0 280 052 A1, wherein a flexible membrane is located along the central axis of a cylindrical housing and the fibres are arranged longitudinally within the housing between said flexible membrane and the inner wall of the cylindrical housing. During filtering operation, the flexible membrane is inflated, in order to compress the fibres between the flexible membrane and the inner wall of the cylindrical housing, thereby providing temporary pores for filtration of a contaminated fluid. The filter can be regenerated in the same way as described above, by deflating the flexible membrane and flushing the system with a flushing fluid. Again, the disadvantage of this technique is that minimal particle size to be separated from the fluid is limited by the size of the temporary pores created by the compressed fibres.

It has been found by experimentation that certain turbid fluids cannot be successfully filtered to the clarity required by the industry using the above described constricted fibre filtration devices alone.

It is also known that filter aids based on particulate minerals can provide the required clarity (see e.g. WO 2009/067718 A1). However, when used with standard industrial filtering technology there can be some drawbacks. For example, a continuous filtrate production requires multiple filter beds in order to manage cleaning operations and disposal of spent filter cake. Existing industrial solutions such as cross-flow membrane technologies are expensive and ongoing maintenance costs can be significant as porous membranes have a limited service life and need replacing at regular intervals.

It is an object of the present invention to provide filtering technologies for turbid fluids, wherein the smaller particle diameter particles can be removed, and having reduced maintenance requirements in terms of expense and time.

### SHORT DESCRIPTION OF THE INVENTION

The present invention is defined in the appended claims.

In particular, the present invention is embodied by a method for filtering fluid suspensions to obtain clarified fluids, the method comprising providing a fluid to be filtered, containing solid particulate contaminants; providing a constricted-fibre filtering device; providing a particulate filter aid; filtering said fluid to be filtered and said particulate filter aid using said constricted-fibre filtering device; and collecting a filtered fluid. Optionally, the collected filtered liquid can be filtered repeatedly using said constricted-fibre filtering device, or it may even be circulated directly from a collection recipient back into the constricted-fibre filtering device.

In one specific embodiment, the used constricted-fibre filtering device is a constricted-fibre filtering device comprising a container extending in a longitudinal direction, such as a cylindrical container, and having an inlet and an outlet; a plurality of fibres arranged along the longitudinal axis within said container; and an elastic inflatable membrane for constricting the fibres of said constricted-fibre filtering device, such that temporary pores are formed between said fibres through which said fluid to be filtered flows during the filtering step. The filtering device may have its elastic inflatable membrane arranged axially along the central longitudinal axis of the said container, with the said fibres located between said elastic inflatable membrane and the inner wall of the said container. In an alternative embodiment of the present invention, the fibres may be arranged axially along the central longitudinal axis of the container, while the elastic inflatable membrane is located between the said fibres and the inner wall of the said container.

In one embodiment of the present invention, a mixture of said fluid to be filtered and said particulate filter aid is formed prior to the filtering step and said mixture is filtered using said constricted-fibre filtering device.

In one alternative embodiment of the present invention, the filtering step consists of an initial pre-loading step, during which the fibres are pre-loaded with said filtering aid, and a subsequent filtering of the fluid to be filtered. The pre-loading may occur in the shape of physical entanglement of the particulate filter aid with the fibres, or any other physical combination of fibres and particulate filter aid.

According to the present invention, the fibres of the constricted fibre filtering device may be arranged in discrete fibre bundles arranged within the housing of the constricted fibre filtering device. The particulate filter aid used in the method according to the present invention may be selected from diatomaceous earth, perlite, or any other suitable media known to the skilled person in the art, or any mixtures of such materials.

The method according to the present invention may further comprise a step of regenerating said constricted-fibre filtering device by decompressing the fibres and flushing the fibres with a flushing liquid after the filtering steps have terminated. In one embodiment of the present invention, the flushing liquid may be recovered after flushing of the constricted-fibre filtering device and the particulate filtering aid may be recovered from the said flushing liquid. The flushing liquid used in the method according to the present invention may be water.

Also part of the present invention is a constricted-fibre filtering device for use in a method according to the present invention, comprising fibres which have been pre-loaded with a particulate filter aid. The particulate filter-aid may be selected from diatomaceous earth and perlite.

The method according to the present invention leads to a synergistic combination of constricted fibre filtration devices with mineral filter-aids which can provide clear filtrates at filtration rates superior to prior art technology. Moreover, the cost of the constricted-fibre filtration system according to the present invention is lower than cross-flow membrane technologies.

### SHORT DESCRIPTION OF THE FIGURES

The invention will be further illustrated by reference to the following figures:

FIG. 1 is a photography of a state of the art constricted-fibre filtering device;

FIG. 2 is a photography of an outer casing, central feed pipe and flexible membrane of a constricted-fibre filtering device with centrally arranged flexible membrane;

FIG. 3 is a photography of a central feed pipe and cylindrical flexible membrane in an inflated state of a constricted-fibre filtering device;

FIG. 4 is a photography of a single fibrous filter element and crimped metal cap of a constricted-fibre filtering device;

FIG. 5 is a schematic representation of a vertical cut through the centre of the constricted-fibre filtering device of FIGS. 1 to 4 in assembled form;

FIG. 6 is a schematic representation of an alternative constricted filtering device;

FIG. 7 is a schematic representation of a vertical cut through the centre of the an alternative constricted-fibre filtering device having centrally arranged filter filter elements;

FIG. 8 is a schematic representation of two fibre bundles for use as filter elements in a constricted-fibre filtering device;

FIG. 9 is a schematic representation of an alternative constricted-fibre filtering device;

FIG. 10 is a schematic representation of fibres from a fibre bundle for use as filter elements in a constricted-fibre filtering device according to the present invention, pre-loaded with a particulate filter aid;

FIG. 11 is a graph representing specific flow-rate and product turbidity according to the comparative example;

FIG. 12 is a graph representing specific flow-rate and product turbidity according to Example 1;

FIG. 13 is a graph representing specific flow-rate and product turbidity according to Example 2.

It is understood that the following description and references to the figures concern exemplary embodiments of the present invention and shall not be limiting the scope of the claims.

### DETAILED DESCRIPTION OF THE INVENTION

The present invention according to the appended claims provides (a) an improved filtering method for use with state of the art constricted-fibre filtering devices, and (b) improved constricted-fibre filtering devices. The present invention allows improved specific flow-rates during filtering operation and reduced product turbidity, when compared to the state of the art.

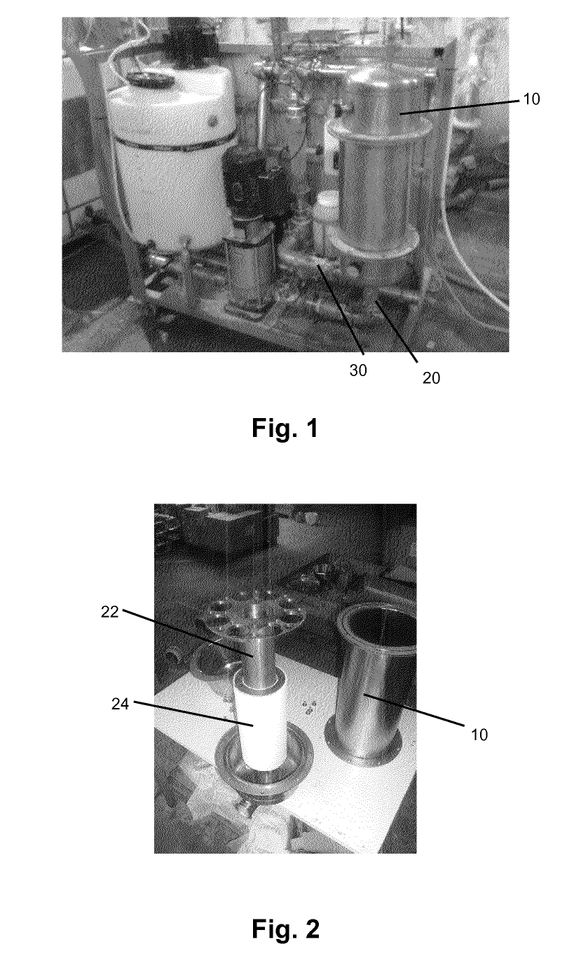

Constricted-fibre filtering devices are known in the art. FIGS. 1 to 5 illustrate a state of the art constricted-fibre filtering device with centrally arranged flexible membrane. FIG. 1 shows an exemplary known constricted-fibre filtering device in assembled form, comprising an outer housing 10, a feed inlet pipe 20 and a product outlet pipe 30. The constricted-fibre filtration device is a system made up of a feed reservoir and associated pipe-work linked to a pump that is capable of delivering a fluid to be filtered from the reservoir into the constricted-fibre filtration device. The product outlet pipe 30 is located at the base of the housing 10 adjacent to the inlet pipe 20 for the fluid to be filtered. Alternatively to the configuration shown in FIG. 1, the feed inlet pipe may also be arranged at the top end of said housing 10. The output from the outlet pipe 30 may be recycled to the feed reservoir or transported by pipe-work to a receiver vessel.

FIGS. 2 to 4 show various internal components of said constricted-fibre filtering device, with the outer housing 10, the central feed pipe 22 and the centrally arranged flexible membrane (bladder) 24 represented in FIG. 2. The flexible central membrane 24 may be constructed from an elastomeric material. The flexible central membrane 24 may be designed such that it surrounds the feed-pipe 22 that enters at the base of the housing 10 and provides the entrance flow path for the fluid to be filtered into the housing 10. Alternatively, the fluid to be filtered may be provided from the top end of the device. Using electronically controlled valves (not shown), the cylindrical bladder 24 can be inflated and deflated as required with a compressed gas, typically air.

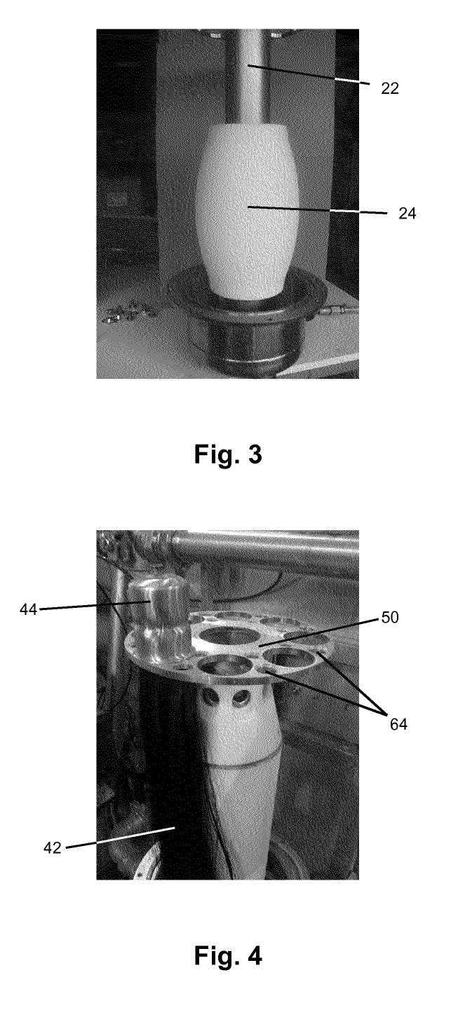

FIG. 3 shows the centrally arranged flexible membrane 24 in an inflated state, with the cylindrical housing of the constricted-fibre filtration device removed.

FIG. 4 shows a filter element 40 in the shape of a bundle of fibres 42, as attached to a top loading surface 50 of the constricted-fibre filtering device using a crimped metal cap 44. The filter element 40 is schematically represented in FIG. 8. Each fibrous filter element 40 is fabricated from a bundle of synthetic fibres 42 of fixed length, bound together at one end by a crimped metal cap 44 designed to retain the fibres, and the synthetic fibres 42 are arranged in a longitudinal direction on one side of said crimped metal cap 44. The filter-elements 40 are arranged at uniform spaces from each other in a circular arrangement on the top loading surface 50 around the centrally located inflatable membrane 24.

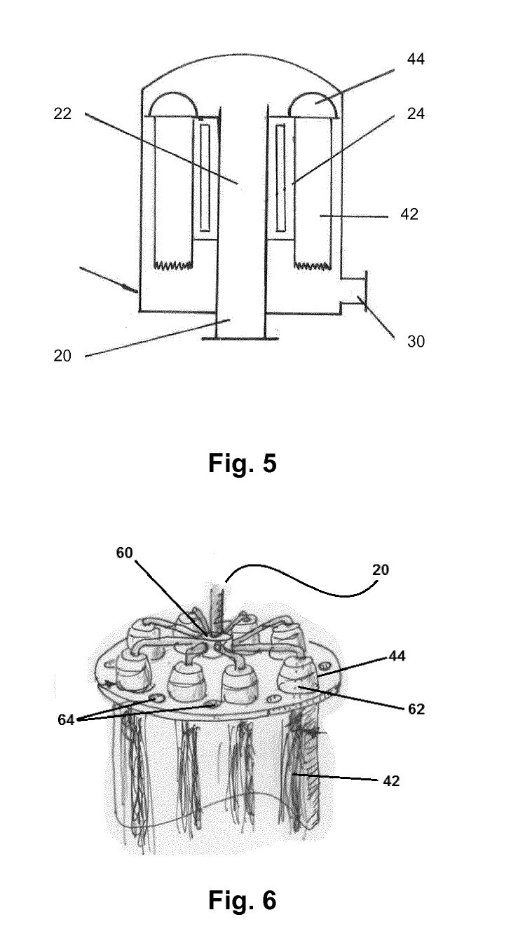

FIG. 5 shows a schematic representation of a vertical cut through the centre of the constricted-fibre filtering device of FIGS. 1 to 4 in assembled form.

The centrally located inflatable membrane 24 may be located such that upon its inflation compression of the fibres occurs at a location such that the distance from the top of the central feed pipe 22 in the housing 10 to the location of maximal lateral compression of the fibres 42 is between 20% and 90% of the total length of the fibre housing, such as between 40% and 80% of the total length of the fibre housing, such as between 50% and 70% or about 60% of the total length of the fibre housing.

At the start of a filtering operation, the cylindrical membrane 24 within the housing 10 of the constricted-fibre filtering device is not inflated. A fluid to be filtered is pumped from the feed reservoir passing through the inlet 20 located at the base of the housing 10 and upwards through the central feed pipe 22. The fluid to be filtered exits the central feed pipe 22 at the top of the central feed pipe 22, above the loading surface 50, and then typically follows a flow path of least resistance around the filtration elements 40, in order to finally exit the housing 10 via the outlet pipe 30. It can then be recycled to the feed reservoir. Alternatively, the inlet 20 is located at the top of the housing 10 and the fluid to be filtered enters the device above the loading surface 50. In one embodiment, the fluid to be filtered can exit a central feed pipe as described above, and the filter aid may be injected via one or more slurry injection points located at the entry to each filter bundle.

According to one embodiment of the present invention, the fluid to be filtered may be provided through a central manifold 60 dividing into several feeds 62 to feed the fluid to be filtered into the filtering device through several entry points. The said entry points may be located below the crimped metal caps 44, being attained by pipes leading through the said crimped metal caps, as shown in FIG. 6. In this way, fluid to be filtered, including a filtering aid may be delivered directly into a filter element 40, reducing the risk of clogging of the device. The central manifold 60 and the feeds 62 should be sized such that an adequate flow of fluid to be filtered and flushing fluid can be ensured. The said feeds 62 may extend into the fibre bundles such that the risk of clogging is further reduced, for example by reaching up to 10 cm into the bundles, or up to 5 cm.

In yet a further embodiment of the present invention, the fluid to be filtered may be introduced into the filtering device through perforated holes 64 located within the top loading surface 50. This may occur through an inlet 20 located at the bottom of the device and via the central feed-pipe 22, or through a separate inlet 20 located near the top of the filtering device above the top loading surface 50. In this embodiment, a particulate filter aid is released through a central manifold 60 and feeds 62. In embodiments of the present invention wherein the said perforated holes 64 are not used, they may not need to be present, or be filled with a sealant, in order to maintain good efficiency of the device.

Once stable flow has been established, the filtration process is initiated and the central membrane 24 is inflated by compressed gas (typically compressed air). Inflation of the membrane 24 causes the filter-elements 40 to be forced outwards against the inner wall of the housing 10 of the constricted-fibre filtering device. This action causes constriction of the filter elements 40 and reduces the spaces between individual fibres, creating a series of temporary inter-fibre pores within the filter elements 40. The fluid to be filtered is now forced to pass between the constricted filter elements 40 in order to exit the constricted-fibre filtering device. The temporary inter-fibre pores can entrap and retain material suspended in the fluid to be filtered, while they allow the liquid component to pass freely, thereby effecting a filtration process. The filtrate finally exits the constricted-fibre filtering device via the outlet pipe 30 located at the base of the housing 10 and can either be fed to a receiver tank or fed back to the feed reservoir.

At some stage in the process an accumulation of material retained by the filter elements 40 may begin to block the filter elements 40 causing the filtrate production rate to slow to below an acceptable level. At this point, the central membrane 24 may be deflated, releasing the constriction of the filter elements 40. This action allows the fibres within the filter elements 40 to separate under the influence of the continued flow of fluid to be filtered, destroying the temporary inter-fibre pores. The accumulated material is thus released from the filter elements 40 and ejected from the housing 10 of the constricted-fibre filtering device as a concentrated slurry and may be diverted to a separate holding tank for further processing. Alternatively, this step can be performed using a flushing liquid, after collection of the filtrate and/or the fluid to be filtered from the system. Once this operation is completed, the membrane can be re-inflated and filtration of the fluid to be filtered resumed.

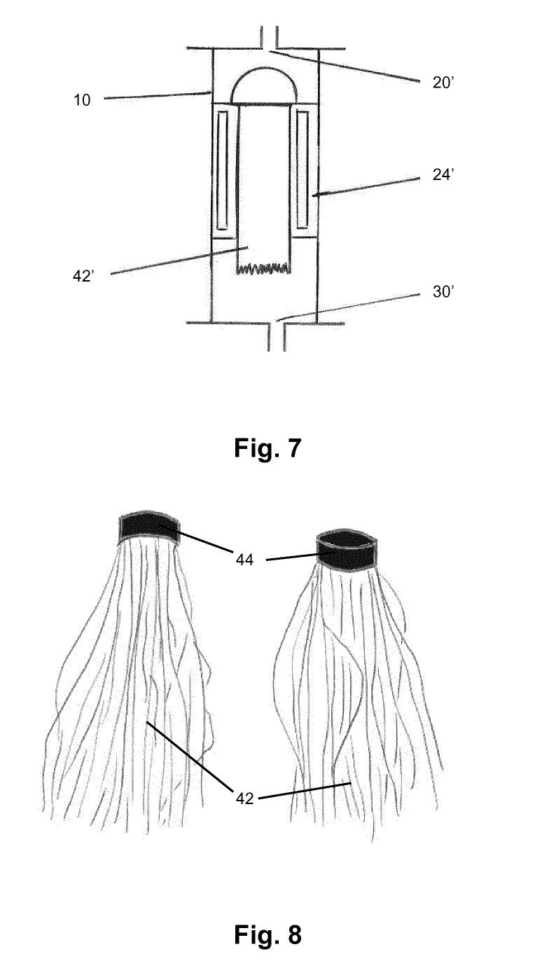

FIG. 7 shows a schematic representation of an alternative embodiment of a constricted-fibre filtering device in assembled form. In this alternative embodiment, an inflatable bladder 24′ is attached around the interior wall of a cylindrical housing 10 around the whole circumference thereof, such that when inflated, the inflatable bladder 24′ reduces the diameter of the cylindrical housing 10. A crimped metal cap 44′ is arranged near an inlet end at the top end of the cylindrical housing 10, and fixes bundle of fibres 42′ extending in a longitudinal direction within the cylindrical housing 10. The fixed bundle of fibres 42′ is formed of filter elements 40′, and the combination of the bundle of fibres 42′ and the crimped metal cap 44′ is arranged such that any liquid introduced into the cylindrical housing 10 through an inlet 20′ near the top of the cylindrical housing 10 is forced to flow along the fixed bundle of fibres 42′ in order to reach an outlet 30′ near the bottom of the cylindrical housing 10.

During operation of said alternative filtering device as represented in FIG. 7, a fluid to be filtered is pumped from a feed reservoir through the inlet 20′ located on the top or alternatively at the base of the cylindrical housing 10 and allowed to flow towards the outlet 30′ through gravitational action or pumping. As soon as stable flow has been established, the filtration process is initiated and the inflatable bladder 24′ is inflated by compressed gas (typically compressed air). Inflation of the membrane 24′ causes the filter elements 40′ to be forced inwards towards each other within the housing 10 of the constricted-fibre filtering device. This action causes constriction of the filter elements 40′ and reduces the spaces between individual fibres, creating a series of temporary inter-fibre pores within the filter elements 40′. The fluid to be filtered is now forced to pass between the constricted filter elements 40′ in order to exit the constricted-fibre filtering device. The temporary inter-fibre pores can entrap and retain material suspended in the fluid to be filtered, while they allow the liquid component to pass freely, thereby effecting a filtration process. The filtrate finally exits the constricted-fibre filtering device via the outlet 30′ located near the base of the cylindrical housing 10 and can either be fed to a receiver tank or fed back to the feed reservoir.

The filter elements 40, 40′ may be formed of fibre bundles consisting of a metal cap 44 and between 3,000 and 80,000 fibres, such as for example 15.000 to 50.000 fibres, such as for example approximately 30.000 fibres. Each fibre may have a thickness ranging from 0.02 mm to 2.0 mm, such as for example from 0.2 mm to 0.5 mm, from 0.5 mm to 1 mm, or from 1 mm to 2 mm. The fibres, both singularly and in combination, may be made of any suitable material known to the skilled person in the art, such as e.g. polyester or polyamide (nylon), or from polymer derivatives or metallic or carbonic (natural and modified) or glass fibres, including mixtures of several materials in a single fibre, or mixtures of fibres of different compositions in a fibre bundle. The fibres may be coated or non-coated. Suitable coatings are known to the skilled person in the art. The fibres may have a circular or a non-circular cross section and may have a consistent or non-consistent (variable) diameter along the entire fibre length. The bundles can have a length of between 50 cm and 150 cm, such as 100 cm, and a diameter between 5 cm and 20 cm, such as of 10 cm. The metal caps 44 are adapted for secure installment in a top loading surface 50 of a constricted-fibre filtering device.

Mineral filter aids are known to the skilled person in the art. They can constitute of particulate material such as diatomaceous earth, or perlite, or mixtures thereof. Methods of preparation of such mineral filter aids are also known (see e.g. WO 2009/067718 A1).

In one aspect, the mineral filter aid can include at least one natural or calcined diatomaceous earth. As used herein, the term “natural diatomaceous earth” means any diatomaceous earth material that has not been subjected to thermal treatment (e.g. calcination) sufficient to induce formation of greater than 1% cristobalite. In some embodiments, the diatomaceous earth is obtained from a saltwater source. In some embodiments, the diatomaceous earth is obtained from a freshwater source.

Diatomaceous earth is, in general, a sedimentary biogenic silica deposit including the fossilised skeletons of diatoms, one-celled algae-like plants that accumulate in marine or fresh water environments. Honeycomb silica structures generally give diatomaceous earth useful characteristics such as absorptive capacity and surface area, chemical stability, and low-bulk density. In some embodiments, diatomaceous earth includes about 90% SiO₂ mixed with other substances. In some embodiments, crude diatomaceous earth includes about 90% SiO₂, plus various metal oxides, such as, but not limited to, Al, Fe, Ca, and Mg oxides.

The average particle size for the diatomaceous earth can range from 5 to 200 μm, with a surface area in the range from 1 to 80 m²/g, a pore volume in the range from 2 to 10 mL/mg and a median pore size in the range from 1 to 20 μm.

The diatomaceous earth may have any of various appropriate forms known to the skilled artisan or hereafter discovered. In some embodiments, the diatomaceous earth is unprocessed (e.g. it is not subjected to chemical and/or physical modification processes). Without wishing to be bound by theory, the impurities in diatomaceous earth, such as clays and organic matters, may, in some instances, provide higher cation exchange capacity. In some embodiments, the diatomaceous earth undergoes minimal processing following mining or extraction. In some embodiments, the diatomaceous earth is subjected to at least one physical modification process. Some examples of possible physical modification processes include, but are not limited to, milling, drying, and air classifying. In some embodiments, the diatomaceous earth is subjected to at least one chemical modification process. An example of a chemical modification processes is silanisation, but other chemical modification processes are contemplated. Silanisation may be used to render the surfaces of the diatomaceous earth either more hydrophobic or hydrophilic using the methods appropriate for silicate minerals.

In another aspect, the mineral filter aid can include a natural glass, such as perlite. The term “natural glass” as used herein refers to natural glasses, commonly referred to as volcanic glasses, that are formed by the rapid cooling of siliceous magma or lava. Several types of natural glasses are known, including, for example, perlite, pumice, pumicite, shirasu, obsidian, and pitchstone. Prior to processing, perlite may be gray to green in colour with abundant spherical cracks that cause it to break into small pearl-like masses. Pumice is a lightweight glassy vesicular rock. Obsidian may be dark in colour with a vitreous luster and a characteristic conchoidal fracture. Pitchstone has a waxy resinous luster and may be brown, green, or gray. Volcanic glasses such as perlite and pumice occur in massive deposits and find wide commercial use. Volcanic ash, often referred to as tuff when in consolidated form, includes small particles or fragments that may be in glassy form. As used herein, the term natural glass encompasses volcanic ash.

Natural glasses may be chemically equivalent to rhyolite. Natural glasses that are chemically equivalent to trachyte, dacite, andesite, latite, and basalt are known but may be less common. The term “obsidian” is generally applied to large numbers of natural glasses that are rich in silica. Obsidian glasses may be classified into subcategories according to their silica content, with rhyolitic obsidians (containing typically about 73% by weight SiO₂) being the most common.

Perlite is a hydrated natural glass that may contain, for example, about 72 to about 75% by weight SiO₂, about 12 to about 14% by weight Al₂O₃, about 0.5 to about 2% by weight Fe₂O₃, about 3 to about 5% by weight Na₂O, about 4 to about 5% by weight K₂O, about 0.4 to about 1.5% by weight CaO, and small amounts of other metallic elements. Perlite may be distinguished from other natural glasses by a higher content (such as about 2 to about 5% by weight) of chemically-bonded water, the presence of a vitreous, pearly luster, and characteristic concentric or arcuate onion skin-like (i.e., perlitic) fractures.

Perlite products may be prepared by milling and thermal expansion, and may possess unique physical properties such as high porosity, low bulk density, and chemical inertness. Average particle size for the milled expanded perlite ranges from 5 to 200 μm, pore volume ranges from 2 to 10 L/mg with median pore size from 5 to 20 μm.

Pumice is a natural glass characterised by a mesoporous structure (e.g. having pores or vesicles with a size up to about 1 mm). The porous nature of pumice gives it a very low apparent density, in many cases allowing it to float on the surface of water. Most commercial pumice contains from about 60% to about 70% by weight SiO₂. Pumice may be processed by milling and classification, and products may be used as lightweight aggregates and also as abrasives, adsorbents, and fillers. Unexpanded pumice and thermally-expanded pumice may also be used as filtration components.

In another aspect the mineral filter aid can comprise a blend of more than one mineral. For example, the mineral filter aid could include a blend of diatomite and a natural glass (e.g., perlite).

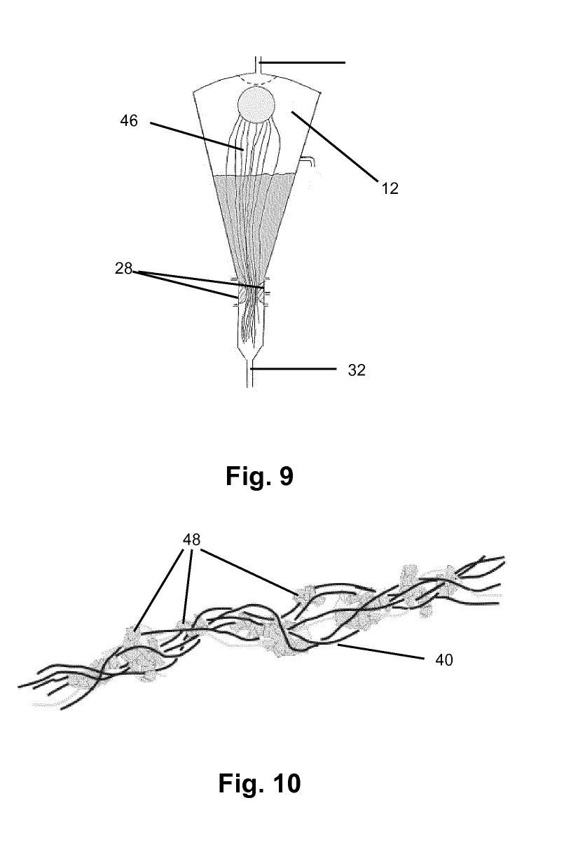

An alternative constricted-fibre filtering device is shown in FIG. 9. It comprises a vertically orientated conical recipient 12, comprising an inlet 26 at the wider top end and an outlet 32 at an elongated narrow lower end, wherein a “jellyfish”-type bundle 46 of fibres is suspended near the top end and an inflatable collar 28 is installed within the interior wall just above the outlet. The fibres of the fibre bundle 46 are orientated vertically such that they reach through the inflatable collar 28 at the bottom of the recipient. During filtering operation, the inflatable collar 28 near the outlet 32 is inflated, causing the fibres located within the collar 28 to be concentrated and form temporary pores as their interstices, in order to act as a fluid filter, retaining particulate contaminants. The filtrate can be collected through the outlet 32. Regeneration of the device is possible by deflation of the collar 28 and flushing with a flushing liquid such as water.

According to the present invention, a synergistic combination of a constricted fibre filtration device with mineral filter-aids is applied, which can provide clear filtrates at improved filtration rates when compared to state of the art. In the hybrid filtration method according to one aspect of the present invention, mineral filter aid particles are added to the fluid to be filtered and introduced into the constricted-fibre filtering device therewith. Alternatively, the filter aid particles may be introduced as a slurry prior to the introduction of the fluid to be filtered. Under the influence of liquid flow, the particulate filter aid passes into the constricted filter elements 40 when the constriction device is inflated. The particles can move into the temporary pores created between the compressed fibres 42 until at some point they become lodged, modifying the size and nature of the inter-fibre pores. This modification allows filtration of fluids to greater clarity to be achieved than with the fibres alone.

In one embodiment of the present invention, the hybrid filtration is achieved by pre-mixing the fluid to be filtered with said mineral filter-aid particles. When the mixture of fluid to be filtered with said mineral filter-aid particles is processed in the constricted-fibre filtering device, said mineral filter-aid particles become lodged within the filter elements as described above, thereby improving the filtering action according to the inventive method.

In an alternative method of the present invention, the hybrid filtration is achieved by pre-loading the filter elements 40 with said mineral filter-aid particles 48 prior to the start of the filtering operation. This may be achieved according to various methods, such as mechanical entanglement or the use of binding agents. For example, if the filter elements 40 consist of polyester or nylon fibres, the addition of a small proportion of low-temperature melting polyethylene filament as a binding agent allows the inclusion of mineral filter-aid particles using simple heat treatment. According to this method, the filter elements used are fibre bundles containing an entanglement of mineral filter-aid particles. During filtering operation, a fluid to be filtered is processed as described above, using said fibre bundles containing an entanglement of mineral filter-aid.

### EXAMPLES

Product-specific flow-rates are expressed in m³ product produced per m² of cross-sectional filtration area per hour (m³/m²/h). Conventional filter-aid filters operate at approximately 0.7 m³/m²/h. In the specific case of fruit juices, cross-flow membrane filters run at even lower specific flow rates, such as 0.03 m³/m²/h.

Product quality is determined by measuring the filtrate turbidity in formazin turbidity units (FTU) using a Hanna model 847492 haze meter.

### Comparative Example

A model filtration challenge fluid comprising a suspension of Ovaltine™ at a concentration of 3 g/L water was prepared. A constricted-fibre filtration device was fitted with eight filter-elements each made from a 5 cm diameter cross-sectional bundle of 0.25 mm diameter nylon fibres. The model suspension was pumped into the constricted fibre filtration device at an initial flow-rate of 800 L/h. The cylindrical membrane was inflated with a pressure of 4 bar and the filtration process allowed to proceed with no further adjustment to the input flow-rate. In this mode of operation, a single filtration cycle was investigated with the product output flow-rate being allowed to decay smoothly over time as solids were filtered out of suspension and accumulate within the filter device.

Product quality was determined during the experiment by measuring the turbidty in formazin turbidity units (FTU) using a Hanna model 847492 haze meter. The target for product quality in terms of turbidity was <10 FTU.

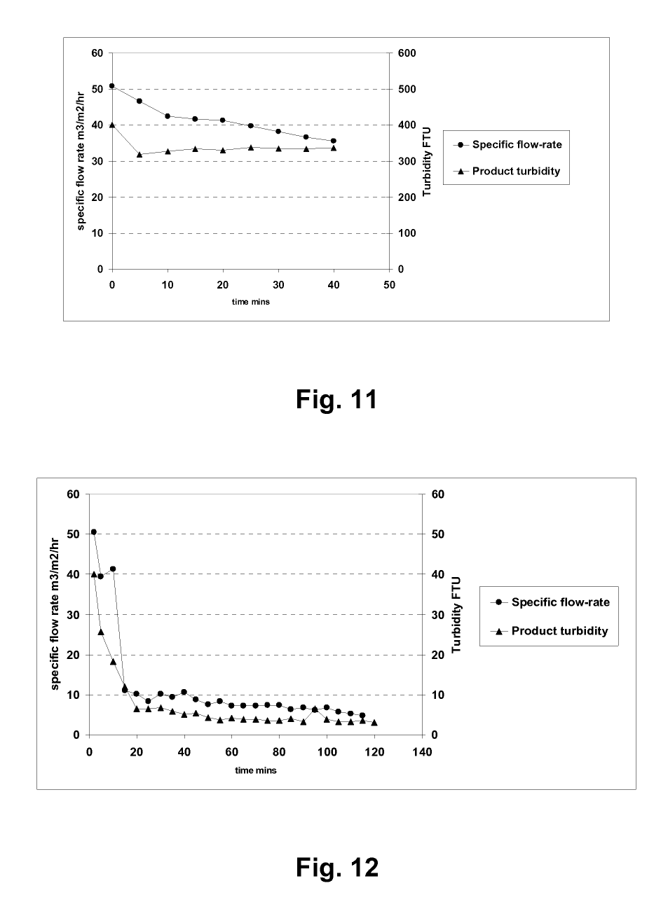

Results are shown in Table I and FIG. 11.

TABLE I

| Time | Product turbidity | Product Flow | specific flow |
|---|---|---|---|
| mins | FTU | Rate L/hr | rate m³/m²/h |
| 0 | 400 | — | 50.8 |
| 5 | 318 | 732 | 46.6 |
| 10 | 328 | 666 | 42.4 |
| 15 | 334 | 654 | 41.6 |
| 20 | 330 | 648 | 41.2 |
| 25 | 338 | 624 | 39.7 |
| 30 | 335 | 600 | 21.3 |
| 35 | 333 | 576 | 36.7 |
| 40 | 337 | 558 | 35.5 |

Although product flow-rate was high, the constricted fibre filtration device was not capable of filtering the model suspension to the clarity required under the conditions described.

### Example 1

A model filtration challenge fluid comprising a suspension of Ovaltine™ at a concentration of 3 g/L water was prepared. The constricted fibre filtration device was fitted with eight filter-elements each made from a 5 cm diameter cross-sectional bundle of 0.25 mm diameter individual polyamide fibres. A particulate diatomaceous filter-aid (Standard Super CeI™; Sigma-Aldrich) was added to the model suspension at a rate of 1.5 g/L and fed into the constricted fibre filtration device at a flow-rate of approximately 800 L/h. The cylindrical member was inflated with a pressure of 4 bar and the filtration process allowed to proceed with no further adjustment to the input flow-rate as in the Comparative Example.

The experimental cycle was carried out until product specific flow-rate fell below 80% of the target (ie. 5.6 m³/m²/h).

Results are shown in table II and FIG. 12.

TABLE II

| Time | Product turbidity | Product Flow | specific flow |
|---|---|---|---|
| mins | FTU | Rate L/hr | rate m³/m²/h |
| 0 | 960 | — | — |
| 2 | 40 | 792 | 50.4 |
| 5 | 25.6 | 619.2 | 39.4 |
| 10 | 18.3 | 648 | 41.3 |
| 15 | 11.9 | 172.8 | 11.0 |
| 20 | 6.4 | 158.4 | 10.1 |
| 25 | 6.4 | 129.6 | 8.3 |
| 30 | 6.8 | 158.4 | 10.1 |
| 35 | 5.8 | 146.4 | 9.3 |
| 40 | 5.1 | 165.6 | 10.5 |
| 45 | 5.41 | 138 | 8.8 |
| 50 | 4.28 | 117.6 | 7.5 |
| 55 | 3.63 | 129.6 | 8.3 |
| 60 | 4.1 | 114 | 7.3 |
| 65 | 3.8 | 112.8 | 7.2 |
| 70 | 3.9 | 112.8 | 7.2 |
| 75 | 3.5 | 116.4 | 7.4 |
| 80 | 3.5 | 116.4 | 7.4 |
| 85 | 4 | 99.6 | 6.3 |
| 90 | 3.2 | 105.6 | 6.7 |
| 95 | 6.5 | 97.2 | 6.2 |
| 100 | 3.8 | 105.6 | 6.7 |
| 105 | 3.2 | 90 | 5.7 |
| 110 | 3.2 | 81.6 | 5.2 |

The time required to reach target clarity was between 15 and 20 minutes. The average specific flow rate over the whole cycle was 9.6 m³/m²/h, exceeding the target by one order of magnitude.

### Example 2

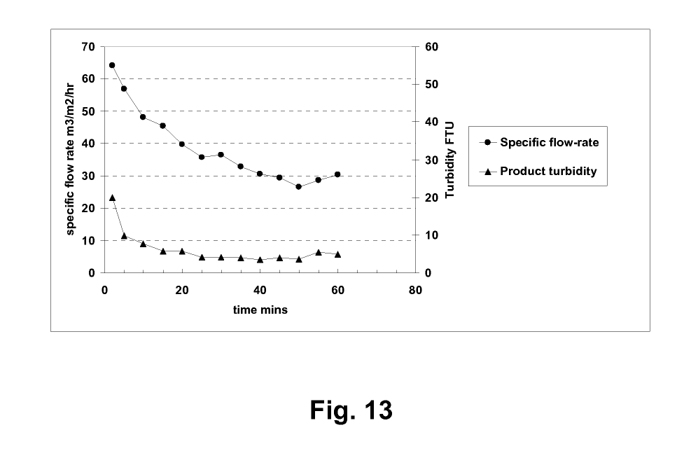

The experimental conditions of Example 1 were repeated, but the initial flow rate was set higher at approximately 1,000 L/h. Results are shown in Table III and FIG. 13.

TABLE III

| Time | Product turbidity | Product Flow | specific flow |
|---|---|---|---|
| mins | FTU | Rate L/hr | rate m³/m²/h |
| 0 | 960 | — | — |
| 2 | 20 | 1008 | 64.2 |
| 5 | 9.8 | 892.8 | 56.8 |
| 10 | 7.7 | 756 | 48.1 |
| 15 | 5.7 | 712.8 | 45.4 |
| 20 | 5.7 | 622.8 | 39.7 |
| 25 | 4.1 | 561.6 | 35.8 |
| 30 | 4.1 | 572.4 | 36.4 |
| 35 | 4 | 514.8 | 32.8 |
| 40 | 3.5 | 478.8 | 30.5 |
| 45 | 3.9 | 460.8 | 29.3 |
| 50 | 3.6 | 417.6 | 26.6 |
| 55 | 5.4 | 450 | 28.7 |
| 60 | 4.9 | 475.2 | 30.3 |

The time required to reach target clarity was below 5 minutes and the average specific flow rate over the whole cycle was 36.9 m³/m²/h. These results are improved further when compared to Example 1.

The specific filtration production flow-rates attained with the method according to the present invention was found to be significantly higher than those reported for state of the art technologies.

1-16. (canceled)

17. A method for filtering fluid suspensions to obtain clarified fluids, the method comprising:
providing a fluid to be filtered, the fluid containing solid particulate contaminants;
providing a constricted-fibre filtering device;
providing a particulate filter aid;
filtering the fluid to be filtered and the particulate filter aid using the constricted-fibre filtering device; and
collecting the filtered fluid.

18. The method of claim 17, further comprising filtering the collected filtered fluid again using the constricted-fibre filtering device.

19. The method of claim 17, wherein the constricted-fibre filtering device comprises:
a container extending in a longitudinal direction along a longitudinal axis and having an inlet and an outlet;
a plurality of fibres arranged along the longitudinal axis within the container; and
an elastic inflatable membrane for constricting the fibres of the constricted-fibre filtering device during filtering, such that temporary pores are formed between the fibres through which the fluid to be filtered flows during filtering.

20. The method of claim 19, wherein the elastic inflatable membrane is arranged axially along the longitudinal axis of the container, and wherein the fibres are located between the elastic inflatable membrane and an inner wall of the container.

21. The method of claim 18, wherein the fibres are arranged axially along the longitudinal axis of the container, and wherein the elastic inflatable membrane is located between the fibres and an inner wall of the container.

22. The method of claim 17, wherein a mixture of the fluid to be filtered and the particulate filter aid is formed prior to filtering, and the mixture is filtered using the constricted-fibre filtering device.

23. The method of claim 17, wherein filtering comprises pre-loading fibres of the constricted-fibre filtering device with the particulate filter aid and subsequently filtering the fluid to be filtered.

24. The method of claim 17, wherein during filtering, the particulate filter aid and the fluid to be filtered are introduced into the constricted-fibre filtering device through separate inlets.

25. The method of claim 17, wherein fibres of the constricted-fibre filtering device of are arranged in discrete fibre bundles.

26. The method of claim 17, wherein the particulate filter aid is selected from diatomaceous earth and natural glass, or a mixture thereof.

27. The method of claim 26, wherein the natural glass is selected from perlite, pumice, pumicite, shirasu, obsidian, and pitchstone, or natural glasses that are chemically equivalent to rhyolite, trachyte, dacite, andesite, latite, and/or basalt.

28. The method of claim 17, further comprising regenerating the constricted-fibre filtering device by flushing fibres of the constricted-fibre filtering device with a flushing liquid after filtering has terminated.

29. The method of claim 28, wherein the flushing liquid is recovered, and the particulate filtering aid is recovered from the flushing liquid.

30. The method of claim 17, wherein the fluid is selected from the group comprising beer, wine, sugar sirup, milk, fruit juice, drinking water, and waste water.

31. A constricted-fibre filtering device for use in the method of claim 17, wherein the constricted-fibre filtering device is characterized in that the fibres of the device are pre-loaded with the particulate filter aid.

32. The constricted-fibre filtering device of claim 31, wherein the particulate filter aid is selected from diatomaceous earth and natural glass, or a mixture thereof, wherein the natural glass is selected from perlite, pumice, pumicite, shirasu, obsidian, and pitchstone, or natural glasses that are chemically equivalent to rhyolite, trachyte, dacite, andesite, latite, and/or basalt.

33. The constricted-fibre filtering device of claim 31, wherein the constricted-fibre filtering device comprises an inlet for receiving a fluid to be filtered and/or particulate filter aid, wherein the inlet comprises a manifold leading to feeds arranged near or within fibres of the constricted-fibre filtering device.
